(19) United States
(12) Patent Application Publication
(10) Pub. No.: US 2020/0238960 A1
(43) Pub. Date: Jul. 30, 2020

(54) ELECTRONIC BRAKING SYSTEM FOR AN IMPLEMENT

(71) Applicant: CNH INDUSTRIAL CANADA, LTD., Saskatoon (CA)

(72) Inventor: Dennis George Thompson, Eagle Ridge (CA)

(73) Assignee: CNH INDUSTRIAL CANADA, LTD.

(21) Appl. No.: 16/261,091

(22) Filed: Jan. 29, 2019

(51) Int. Cl. B60T 7/20; A01B 59/00; B60D 1/24

(52) U.S. Cl. CPC B60T 7/20; B60D 1/242; A01B 59/002

(57) ABSTRACT

An agricultural implement is provided. The agricultural implement includes a braking system configured to slow or stop the agricultural implement. The agricultural implement also includes a hitch configured to couple the agricultural implement to a towing vehicle. The agricultural implement further includes an electronic sensor disposed on the hitch and configured to sense tension and compression forces. The agricultural implement further includes a controller configured to automatically actuate or disengage the braking system in response to a signal indicating a presence of compression or tension forces from the electronic sensor.

### BACKGROUND

The disclosure relates generally to an agricultural implement and, more specifically, an electronic braking system for an implement.

Generally, an agricultural implement may be towed behind an off-road vehicle, such as a tractor, in a field or in some cases on a road. In certain cases, more than one agricultural implement may be towed. For example a seed drill, an air cart, and/or a fertilizer wagon may be coupled in series behind the towing vehicle. Implement braking systems may be employed to keep the implement from over-running the towing vehicle or skewing off the road or into incoming traffic (e.g., jack-knifing). However, these implement braking systems are typically complex (e.g., mechanical/hydraulic surge braking devices). In addition, these implement braking systems may require manual input from the operator (e.g., in the towing vehicle) to activate or actuate the brakes independent of the towing vehicle.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In one embodiment, an agricultural implement is provided. The agricultural implement includes a braking system configured to slow or stop the agricultural implement. The agricultural implement also includes a hitch configured to couple the agricultural implement to a towing vehicle. The agricultural implement further includes an electronic sensor disposed on the hitch and configured to sense tension and compression forces. The agricultural implement further includes a controller configured to automatically actuate or disengage the braking system in response to a signal indicating a presence of compression or tension forces from the electronic sensor.

In another embodiment, a braking system for an agricultural implement includes an electronic sensor configured to be disposed on a hitch of the agricultural implement and to sense compression and tension forces. The braking system also includes one or more wheel brake assemblies configured to slow or stop the agricultural implement when the agricultural implement is being towed by a towing vehicle. The braking system further includes a controller configured to automatically actuate or disengage the one or more wheel brake assemblies in response to a signal indicating a presence of tension or compression forces from the electronic sensor.

In a further embodiment, a method for utilizing a braking system for an agricultural implement is provided. The method includes receiving, at a controller, a first signal representative of compression force from an electronic sensor disposed on a hitch of the agricultural implement when the agricultural implement is being towed by a towing vehicle. The method also includes automatically actuating, via the controller, the braking system of the agricultural implement to slow or stop the agricultural implement in response to the signal.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system with an agricultural implement having an electronic braking system, in accordance with an aspect of the present disclosure;

FIG. 2 is a side view of an embodiment of an air cart that may employ the electronic braking system, in accordance with an aspect of the present disclosure;

FIG. 3 is a schematic view of an embodiment of an agricultural implement having an electronic braking system, in accordance with an aspect of the present disclosure;

FIG. 4 is a flowchart of an embodiment of a method for utilizing the electronic braking system of FIG. 3, in accordance with an aspect of the present disclosure; and

FIG. 5 is a flowchart of an embodiment of a method for utilizing the electronic braking system of FIG. 3 (e.g., utilizing sensors in both the hitch and other areas of the agricultural implement), in accordance with an aspect of the present disclosure

### DETAILED DESCRIPTION OF THE DRAWINGS

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

With the increasing size of towed implements (and implement trains) and a heightened concern for on-road transport safety, there is an increased need for dedicated, on-board implement braking systems. In particular, there is a need for these dedicated, on-board implement braking systems to provide hill decent control in downhill road transport scenarios where braking of large, heavy implements may occur to avoid the implement from over-running the towing vehicle or “jack-knifing”.

Accordingly, as will be described in more detail below, embodiments described herein provide an electronic on-board implement braking system (e.g., surge braking system). For example, one or more electronic sensors or actuators are coupled to a hitch. The one or more electronic sensors or actuators may sense compression and tension forces (e.g., acting on the hitch) and provide one or more electrical signals to a controller on the implement. In response to these signals, the controller automatically (i.e., without operator input) actuates the braking (or increases the braking force) using the wheel brake assemblies of the implement braking system to slow or stop the agricultural implement or automatically (i.e., without operator input) disengages the braking system (if currently engaged). In certain embodiments, the controller may also take into account feedback relating to operating conditions of the implement (e.g., implement weight, downhill inclination, hitch compression rate, etc.) and automatically adjust the brake system response accordingly. Replacing the mechanical surge brake actuator with an electronic sensor also provides the advantage of reducing system cost and complexity. In addition, utilization of the electronic sensor in the electronic on-board implement braking system can provide safer, more effective automatic brake activation than a manually-applied braking system can provide.

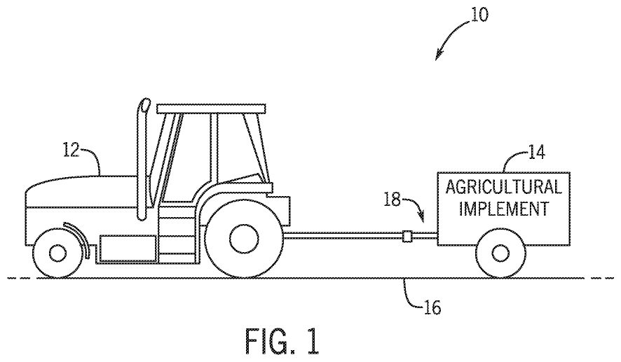

FIG. 1 is a side view of an embodiment of an agricultural system 10. The agricultural system 10 includes a tow vehicle 12 and an agricultural implement 14. The tow vehicle 12 may be any vehicle suitable for towing the agricultural implement 14, such as a tractor, off-road vehicle, work vehicle, and so forth. Additionally, the agricultural implement 14 may be any implement suitable for agricultural use, such as a tillage implement, a fertilizer implement, a seeding implement and an air cart, or another agricultural implement. In certain embodiments, one or more additional implements may be coupled to and towed behind the agricultural implement 14. The agricultural system 10 travels over a surface 16, such as the ground, a road, a field, or another surface.

The tow vehicle 12 is coupled to the agricultural implement 14 by a hitch assembly 18 (e.g., hitch). In certain scenarios (e.g., traveling downhill, uphill, etc.), off-road or on road, the hitch assembly 18 may experience forces (e.g., tension and/or compression forces). As described in greater detail below, the hitch assembly 18 includes one or more electronic sensors or actuators that are utilized instead of a mechanical/hydraulic mechanism (e.g., hydraulic cylinder) to sense these forces and actuate the braking system. These electronics sensors or actuators provide feedback to a dedicated, on-board implement braking system (e.g., surge braking system) to automatically activate (e.g., in response to compression forces) or disengage (e.g., in response to tension forces) the brakes of the implement braking system in response to the sensed forces.

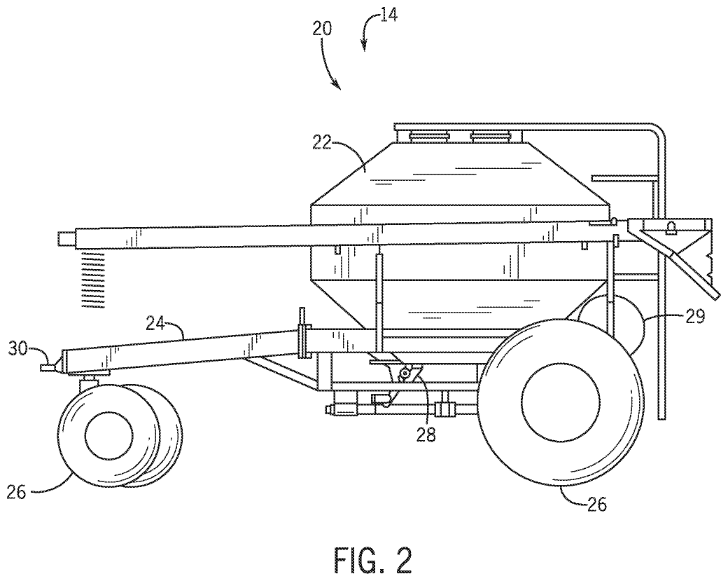

An example of the agricultural implement 14 (e.g., large agricultural implement) that includes the dedicated, on-board implement braking system is provided in FIG. 2. FIG. 2 illustrates a side view of an air cart 20 that may be used in conjunction with a towable agricultural implement to deposit seeds into the soil. More specifically, the air cart 20 may be used to centrally store seeds and distribute the seeds to the agricultural implement. Accordingly, in the illustrated embodiment, the air cart 20 includes a storage tank 22, a frame 24, wheels 26, a metering assembly 28, and an air source 29. In the depicted embodiment, the air cart frame 24 is typically coupled to another agricultural implement or an off-road work vehicle (i.e., towing vehicle) via a hitch 30. As such, the wheels 26 may contact the soil surface to enable the air cart 20 to be towed. The hitch 30 may include one or more electronic sensors or actuators disposed on it to sense compression or tension forces and the air cart 20 may include the dedicated, on-board implement braking system as described in greater detail below.

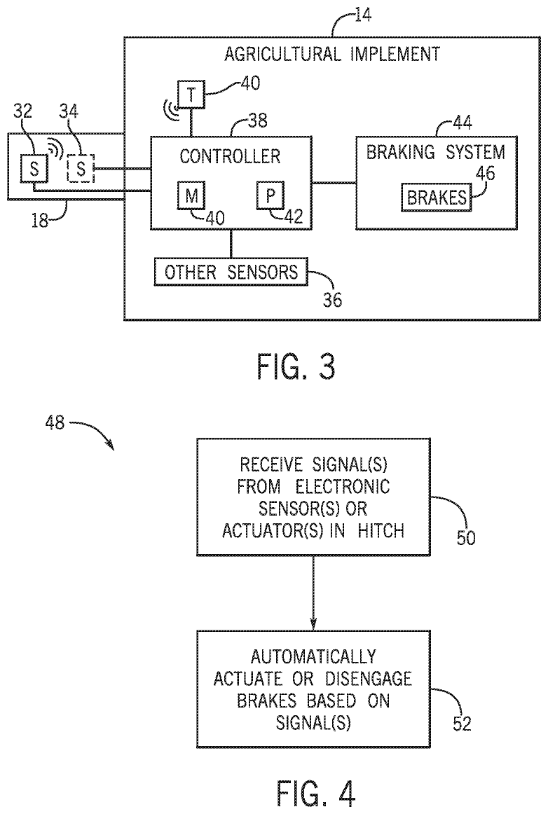

To more clearly illustrate, a schematic view of the agricultural implement 14 having a dedicated, on-board implement braking system is provided in FIG. 3. As illustrated, the agricultural implement 14 includes the hitch 18. The hitch 18 includes an electronic sensor or actuator 32 to sense compression and tension forces acting on the hitch 18 when being towed by a towing vehicle. In certain embodiments, the hitch may include one or more additional electronic sensors or actuators such as electronic sensor or actuator 34 to also sense compression or tension forces or another parameter related to an operating condition of the implement 14. The sensor 32 may include a linear actuator (e.g., wire or cable), contact sensor (e.g., switch), or potentiometer. In certain embodiments, the sensor 34 may include the linear actuator, contact sensor, potentiometer, or angle or tilt sensor (e.g., gyroscope, accelerometer, microelectromechanical (MEMS) based sensor, etc.). In certain embodiments, the agricultural implement 14 may include one or more additional sensors 36 disposed throughout the implement 14. The sensors 36 provide feedback or signals related to an operating condition of the implement 14. For example, the sensors 36 may include an angle or tilt sensor, a sensor for determining implement weight, or other sensors. The sensors 36 may provide information related to the hitch compression rate, the weight of the implement 14, a downhill inclination of the implement 14, or another operating condition.

The sensors 32, 34, 36 provide the signals or feedback to a controller 38. The sensors 32, 34, 36 may be in communication with the controller 38 via electrical conduits. In certain embodiments, the sensors 32, 34, 36 may include transceivers that enable them to wirelessly communicate with a transceiver 40 coupled to the controller 38. The controller 38 includes a memory 40 and a processor 42. In some embodiments, the processor 42 may include one or more general purpose processors, one or more application specific integrated circuits, one or more field programmable gate arrays, or the like. Additionally, the memory 40 may be any tangible, non-transitory, computer readable medium that is capable of storing instructions executable by the processor 42 and/or data that may be processed by the processor 42. In other words, the memory 40 may include volatile memory, such as random access memory, or non-volatile memory, such as hard disk drives, read only memory, optical disks, flash memory, and the like.

The controller 38 is coupled to a braking system 44 (e.g., surge braking system). The braking system 44 includes brakes 46 (e.g., respective brakes associated with respective wheels of the implement 14) that enable the slowing down or stopping of the implement 14. The brakes 46 may include conventional hydraulic drum or disc brakes or another type of brake. The controller 38 is configured to receive feedback from sensors 32, 34 regarding the compression or tension forces acting on the hitch 18. In certain embodiments, when the controller 38 receives an indication of compression force acting on the hitch 18, the controller 38 causes the actuation (or increase in applied brake force) of the brakes 46 of the braking system 44. When the controller 38 receives an indication of tension force acting on the hitch 18, the controller 38 causes the disengagement of the brakes 46 of the braking system 44 (if currently engaged). In certain embodiments, the controller 38 is configured to receive feedback from other sensors 36 related to the operating condition of the implement 14 (e.g., weight of the implement, downhill inclination, hitch compression rate, etc.). In certain embodiments, some parameters related to the operating condition of the implement 14 may be stored in the memory 40 instead of received from a sensor (e.g., weight of the implement 14). In certain embodiments, based on an indication of compression force acting on the hitch 18 and an operating condition of the implement 14 (e.g., inclined downhill, sufficient hitch compression rate, sufficient weight of the implement 14, etc.), the controller 38 causes the actuation (or increase in applied brake force) of the brakes 46 of the braking system 44. Based on an indication of tension force acting on the hitch 18 and an operating condition of the implement 14 (e.g., level or inclined uphill, insufficient hitch compression rate, etc.), the controller 38 causes the disengagement of the brakes 46 of the braking system 44 (if currently engaged).

FIG. 4 is a flowchart of an embodiment of a method 48 for utilizing the electronic braking system of FIG. 3. The steps of the method 48 may be performed by the controller 38 of the agricultural implement 14 described above. The method 48 includes receiving one or more signals from one or more electronic sensors or actuators 32, 34 coupled to the hitch 18 of the implement 14 (block 50). As noted above, the sensors 32, 34 provide feedback regarding the compression or tension forces acting on the hitch 18. The method 48 also includes automatically actuating (or increasing applied brake force) or disengaging (if currently engaged) the brakes 44 of the braking system 46 based on the feedback form the sensors 32, 34 (block 52). For example, when the controller 38 receives an indication of compression force acting on the hitch 18, the controller 38 causes the actuation (or increase in applied brake force) of the brakes 46 of the braking system 44. When the controller 38 receives an indication of tension force acting on the hitch 18, the controller 38 causes the disengagement of the brakes 46 of the braking system 44 (if currently engaged).

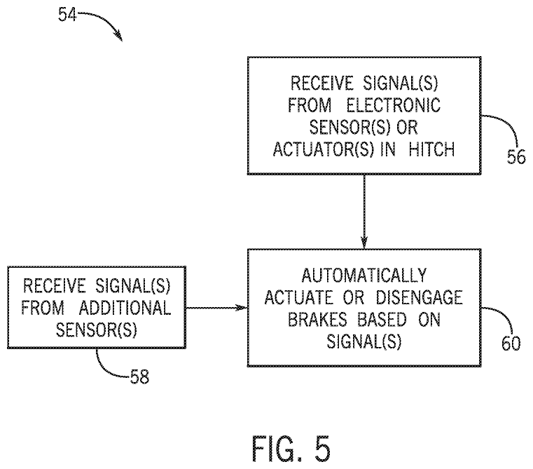

FIG. 5 is a flowchart of an embodiment of a method 54 for utilizing the electronic braking system of FIG. 3 (e.g., utilizing sensors in both the hitch and other areas of the agricultural implement). The steps of the method 54 may be performed by the controller 38 of the agricultural implement 14 described above. The method 54 includes receiving one or more signals from one or more electronic sensors or actuators 32, 34 coupled to the hitch 18 of the implement 14 (block 56). As noted above, the sensors 32, 34 provide feedback regarding the compression or tension forces acting on the hitch 18. The method 54 also includes receiving one or more signals from one or more additional sensors 36 distributed about the agricultural implement 14 (block 58). As noted above, the additional sensors 36 provide feedback related to the operating condition of the implement 14. For example, the feedback may relate to weight of the implement, downhill inclination, hitch compression rate, or another parameter. In certain embodiments, some parameters related to the operating condition of the implement 14 may be stored in the memory 40 instead of received from a sensor (e.g., weight of the implement 14). The method 54 also includes automatically actuating (or increasing applied brake force) or disengaging (if currently engaged) the brakes 44 of the braking system 46 based on the feedback form the sensors 32, 34, 36 (block 60). For example, based on an indication of compression force acting on the hitch 18 and an operating condition of the implement 14 (e.g., inclined downhill, sufficient hitch compression rate, sufficient weight of the implement 14, etc.), the controller 38 causes the actuation (or increase in applied brake force) of the brakes 46 of the braking system 44. Based on an indication of tension force acting on the hitch 18 and an operating condition of the implement 14 (e.g., level or inclined uphill, insufficient hitch compression rate, etc.), the controller 38 causes the disengagement of the brakes 46 of the braking system 44 (if currently engaged).

While only certain features of the disclosure have been illustrated and described herein, many modifications and changes will occur to those skilled in the art. It is, therefore, to be understood that the appended claims are intended to cover all such modifications and changes as fall within the essence of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An agricultural implement, comprising:
a braking system configured to slow or stop the agricultural implement;
a hitch configured to couple agricultural implement to a towing vehicle;
an electronic sensor disposed on the hitch and configured to sense compression and tension forces; and
a controller configured to automatically actuate or disengage the braking system in response to a signal indicating a presence of compression or tension forces from the electronic sensor.

2. The agricultural implement of claim 1, wherein the electronic sensor comprises a linear actuator, contact sensor, or potentiometer.

3. The agricultural implement of claim 3, comprising one or more additional sensors configured to sense an operating condition of the agricultural implement.

4. The agricultural implement of claim 4, wherein the controller is configured to automatically actuate or disengage the braking system in response to both the signal indicating a presence of compression or tension forces from the electronic sensor and one or more signals indicating the operating condition of the agricultural implement received form the one or more additional sensors.

5. The agricultural implement of claim 3, wherein the operating condition comprises a weight of the agricultural implement, a downhill inclination of the agricultural implement, or a hitch compression weight.

6. The agricultural implement of claim 1, wherein the agricultural implement comprises an air cart.

7. The agricultural implement of claim 1, wherein the braking system comprises a surge braking system.

8. A braking system for an agricultural implement, comprising:
an electronic sensor configured to be disposed on a hitch of the agricultural implement and to sense compression and tension forces;
one or more wheel brake assemblies configured to slow or stop the agricultural implement when the agricultural implement is being towed by a towing vehicle; and
a controller configured to automatically actuate or disengage the one or more wheel brake assemblies in response to a signal indicating a presence of compression or tension forces from the electronic sensor.

9. The braking system of claim 8, wherein the electronic sensor comprises a linear actuator, contact sensor, or potentiometer.

10. The braking system of claim 8, comprising one or more additional sensors configured to sense an operating condition of the agricultural implement.

11. The braking system of claim 10, wherein the controller is configured to automatically actuate or disengage the one or more wheel brake assemblies in response to both the signal indicating a presence of compression or tension forces from the electronic sensor and one or more signals indicating the operating condition of the agricultural implement received form the one or more additional sensors.

12. The braking system of claim 8, wherein the operating condition comprises a weight of the agricultural implement, a downhill inclination of the agricultural implement, or a hitch compression weight.

13. The braking system of claim 8, wherein the braking system comprises a surge braking system.

14. A method for utilizing a braking system for an agricultural implement, comprising:
receiving, at a controller, a first signal representative of compression force from an electronic sensor disposed on a hitch of the agricultural implement when the agricultural implement is being towed by a towing vehicle; and
automatically actuating, via the controller, the braking system of the agricultural implement to slow or stop the agricultural implement in response to the signal.

15. The method of claim 14, comprising:
receiving, at the controller, one or more additional signals representative of an operating condition of the agricultural implement from one or more additional sensors disposed on the agricultural implement; and
automatically actuating, via the controller, the braking system of the agricultural implement to slow or stop the agricultural implement in response to the signal and the operating condition of the agricultural implement.

16. The method of claim 15, wherein the operating condition comprises a weight of the agricultural implement, a downhill inclination of the agricultural implement, or a hitch compression weight.

17. The method of claim 14, wherein the electronic sensor comprises a linear actuator, contact sensor, or potentiometer.

18. The method of claim 14, comprising:
receiving, at the controller, a second signal representative of tension force from the electronic sensor disposed on the hitch of the agricultural implement; and
automatically diengaging, via the controller, the braking system of the agricultural implement.

19. The method of claim 18, comprising:
receiving, at the controller, one or more additional signals representative of an operating condition of the agricultural implement from one or more additional sensors disposed on the agricultural implement; and
automatically disengaging, via the controller, the braking system of the agricultural implement in response to the signal and the operating condition of the agricultural implement.

20. The method of claim 14, wherein the braking system comprises a surge braking system.
